(19) United States
(12) Patent Application Publication
(10) Pub. No.: US 2026/0289364 A1
(43) Pub. Date: Sep. 24, 2026

(54) METRIC BASED QUANTUM PROCESSOR RE-CALIBRATION

(71) Applicant: Google LLC, Mountain View, CA (US)

(72) Inventors: Julian Shaw Kelly, Santa Barbara, CA (US); Paul Klimov, Santa Barbara, CA (US)

(21) Appl. No.: 19/473,230

(22) PCT Filed: Apr. 7, 2023
(86) PCT No.: PCT/US2023/017971

§ 371 Date: Oct. 7, 2025

(51) Int. Cl. G06N 10/20; G06N 10/40

(52) U.S. Cl. CPC G06N 10/20; G06N 10/40

(57) ABSTRACT

Methods, systems, and apparatus for targeted quantum processor recalibration. In one aspect, a method includes obtaining normalized values of quantum processor system metrics, wherein the system metrics comprise single qubit metrics and two qubit metrics; determining, for each single qubit metric, an effective single qubit metric, wherein the effective single qubit metric comprises the single qubit metric and a sum of two qubit metrics corresponding to pairs of qubits that include a same qubit as the single qubit metric; computing, using the normalized values of the system metrics, values of the effective single qubit metrics; combining, for each qubit referenced by single qubit metrics in the system metrics, effective single qubit metrics that correspond to the qubit to obtain a score for the qubit; and causing recalibration of operating parameters of qubits with scores that exceed a predetermined outlier threshold.

### BACKGROUND

This specification relates to quantum computing.

Quantum computations are physically realized through the time-evolution of quantum systems steered by analog control signals. As quantum information is stored in continuous amplitudes and phases, these control signals must be carefully chosen to achieve the desired result. Calibration is the process of performing a series of experiments on the quantum system to learn optimal control parameters.

### SUMMARY

This specification relates to re-calibration of quantum processor operating parameters using system metrics that characterize the performance of the quantum processor.

In general, one innovative aspect of the subject matter described in this specification can be implemented in a computer implemented method that includes obtaining a set of normalized values of system metrics for a quantum processor, wherein the system metrics comprise single qubit metrics that correspond to respective qubits and two qubit metrics that correspond to respective pairs of qubits; determining, for each single qubit metric, an effective single qubit metric, wherein the effective single qubit metric comprises the single qubit metric and a sum of two qubit metrics corresponding to pairs of qubits that include a same qubit as the single qubit metric: computing, using the normalized values of the system metrics, values of the effective single qubit metrics; combining, for each qubit referenced by single qubit metrics in the system metrics, effective single qubit metrics that correspond to the qubit to obtain a score for the qubit; and causing recalibration of operating parameters of qubits with scores that exceed a predetermined outlier threshold.

Other implementations of this aspect include corresponding classical and quantum computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the operating parameters of a qubit comprise control signals for performing single qubit operations using the qubit.

In some implementations the control signals for performing single qubit operations using the qubit comprise an idling control signal, and wherein causing recalibration of the idling control signal further comprises causing recalibration of control signals for performing two qubit operations using pairs of qubits that include the qubit.

In some implementations the method further comprises combining, for each pair of qubits referenced by two qubit metrics in the system metrics, normalized values of the two qubit metrics that correspond to the pair of qubits to obtain a score for the pair of qubits; and causing recalibration of operating parameters of pairs of qubits with scores that exceed the predetermined outlier threshold.

In some implementations the system metrics further comprise readout metrics that correspond to respective qubits and reset metrics that correspond to respective qubits, and wherein the method further comprises: combining, for each qubit referenced by the readout metrics or reset metrics in the system metrics, normalized values of the readout metrics or reset metrics that correspond to the qubit; and causing recalibration of operating parameters of qubits with scores that exceed the predetermined outlier threshold.

In some implementations an effective single qubit metric for a single qubit metric further comprises a predefined combination factor, wherein the combination factor represents a threshold number of values of two qubit metrics that exceed the predetermined outlier threshold.

In some implementations a larger combination factor decreases a likelihood that an idling control signal for a qubit corresponding to the single qubit metric will require recalibration to move the idling control signal at least a predefined minimum distance away from a defect in a control signal spectrum for the qubit.

In some implementations determining an effective single qubit metric comprises determining a sum of two qubit metrics that correspond to pairs of qubits that include the qubit that corresponds to the single qubit metric divided by the combination factor.

In some implementations combining effective single qubit metrics that correspond to the qubit to obtain a score for the qubit comprises adding terms of the effective single qubit metrics in quadrature, wherein sign is preserved.

In some implementations obtaining the set of normalized values of the system metrics comprises: receiving a set of un-normalized values of the system metrics; computing, using the received set of un-normalized values, a mean or median and standard deviation of each system metric over qubits that correspond to the system metric; and computing a z-score for each value of the system metric using the mean or median and standard deviation.

In some implementations the values of the system metrics comprise measured or modelled values.

In some implementations each system metric corresponds to a respective operation, a respective qubit or pair of qubits, and a respective measure of performance.

In some implementations the set of normalized values of system metrics are obtained after the quantum processor has been calibrated.

The subject matter described in this specification can be implemented in particular ways so as to realize the following advantages.

A purpose of quantum processor calibration is to rapidly and reliably achieve (1) high system performance where all calibrations succeeded, all operating parameters are set within hardware specifications, and all computational elements perform well enough to execute quantum algorithms of interest with high performance, and (2) high stability, where high system performance is maintained over long periods of time, e.g., where long is defined relative to the length of time it takes to calibrate a quantum processor and to execute quantum algorithms of interest.

However, quantum processor calibration is challenging for a number of reasons. Analog control requires careful control-pulse shaping as any deviation from the ideal will introduce error. Qubits require individual calibration as variations in the control system and qubits necessitate different control parameters to hit target fidelities. Optimal control parameters can also drift in time, requiring calibrations to be revisited to maintain performance. Drift can be slow, e.g., seconds to days but continuous, and/or catastrophic, e.g., seconds to days and discontinuous. Additionally, the full calibration procedure requires bootstrapping: using a series of control sequences with increasing complexity to determine circuit and control parameters to increasingly higher degrees of precision. Lastly, each qubit needs to perform a number of independent operations which are independently calibrated: single-qubit gates, two-qubit gates, readout, and reset.

Many conventional quantum processor calibration techniques, i.e., techniques that are different to those described in this specification, lead to low system performance and/or low stability due to some combination of the difficulties described above as well as issues with imperfect calibration models, e.g., due to unknown or poorly understood physical error mechanisms. Furthermore—given a fixed computing architecture—the probability of achieving high system performance and high stability becomes increasingly unfavorable (often exponentially) as the number of computational elements grows due to probabilistically compounding failure rates. This complexity poses a significant obstacle for future scalability and thus commercially-relevant quantum computing.

The presently described quantum processor calibration techniques improve quantum processor calibration by targeting operating parameters that require recalibration. Quantum processor performance metrics across a collection of qubits typically follows a normal distribution, with a small number of outlier qubits that perform anomalously worse than the main distribution. This presently described quantum processor calibration techniques identify such outlier qubits so that the outlier qubits can be recalibrated and brought in-family with the typical distribution. Accordingly, the performance of the quantum processor is improved since the number of poor-performance qubits is reduced.

Further, the presently described quantum processor calibration techniques use effective performance metrics that take dependencies between single qubit and multi-qubit performance metrics into account. In particular, the effective performance metrics are based on a dependency between single qubit idling frequencies and two qubit frequency trajectories, e.g., a dependency that reflects how a qubit idling frequency sets the start/end of the frequency trajectory the qubit takes to reach the interaction frequency. This enables the calibration process to achieve an optimal balance between single qubit performance and two qubit performance. Further, since elements that are re-calibrated affect more than one metric at a time, this enables informed decisions to be made about when to recalibrate certain elements.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example quantum computing system that implements qubit calibration with targeted recalibration.

FIG. 2 is a block diagram of an example workflow for calibrating a calibration target of a quantum processor.

FIG. 3 is a flowchart of an example process for identifying qubit operating parameters that require recalibration.

FIG. 4 is a table that shows example un-normalized values of a set of system metrics for a quantum processor.

FIG. 5 is a table that shows example normalized values of un-normalized values of a set of system metrics.

FIG. 6 is a table that shows example values of effective single qubit metrics for normalized values of a set of system metrics.

FIG. 7 is a table that shows example qubit scores for the effective single qubit metrics and two qubit metrics included in the set of system metrics.

FIG. 8 depicts an example quantum processor.

Like reference numbers and designations in the various drawings indicate like elements.

### DETAILED DESCRIPTION

A quantum processor must perform many operations on many qubits, each of which with high performance. It is common to observe that quantum processor performance metrics across a collection of qubits follows a normal distribution, with a small number of outlier qubits that perform anomalously worse than the main distribution. This specification describes techniques for recalibrating such outlier qubits to bring the outlier qubits in-family with the typical distribution, whilst performing a minimal amount of calibration work.

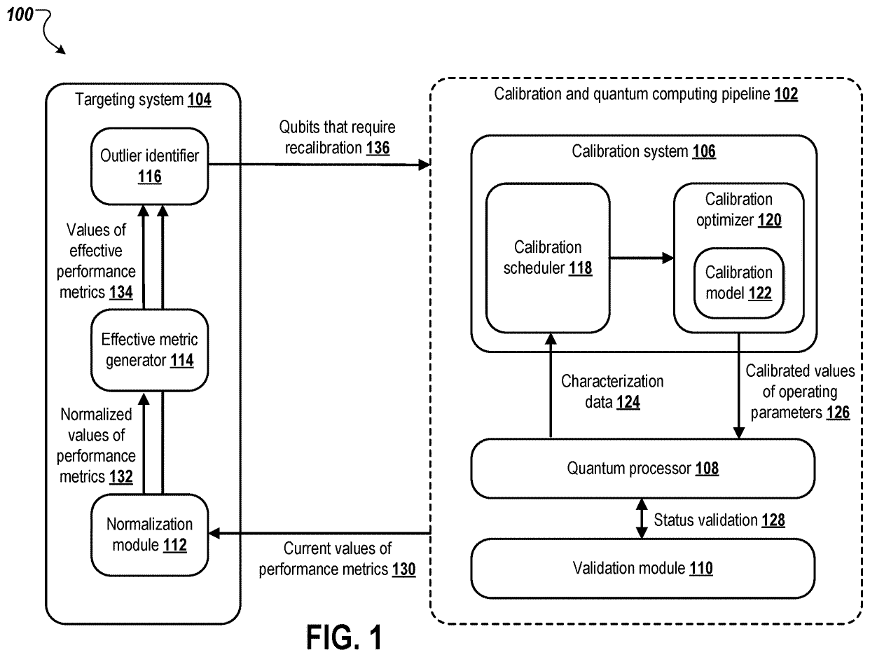

FIG. 1 is a block diagram of an example quantum computing system 100 that implements qubit calibration with targeted recalibration. The system 100 is an example of a system implemented as computer programs on one or more classical and quantum computing devices in one or more locations, in which the systems, components, and techniques described in this specification can be implemented. The system 100 includes a calibration and quantum computing pipeline 102 and a targeting system 104. The calibration and quantum computing pipeline 102 includes a calibration system 106, a quantum processor 108, and a validation module 110. The targeting system 104 includes a normalization module 112, an effective metric generator 114, and an outlier identifier 116. Components of the system 100 can be in data communication with each other, e.g., through a communication network such as a local area network or wide area network.

The quantum processor 108 is configured to perform quantum computations. The quantum processor 108 includes classical and quantum computing elements. For example, the quantum processor 108 includes multiple physical qubits that interact via respective interactions. The qubits can be used to perform algorithmic operations or quantum computations. The specific realization of the one or more qubits and their interactions may depend on a variety of factors including the type of quantum computations that the quantum processor is performing. For example, the qubits may include qubits that are realized via atomic, molecular or solid-state quantum systems. In other examples the qubits may include, but are not limited to, superconducting qubits or semi-conducting qubits.

In some implementations the interacting qubits can be frequency tunable. That is, each qubit can have associated operating frequencies that can be adjusted, e.g., using control devices, through application of voltage pulses via a driveline coupled to the qubit. Different frequencies correspond to different operations that the qubit can perform. For example, the operating frequency can be set to a corresponding idling frequency may put the qubit into a state where it does not strongly interact with other qubits. As another example, the operating frequency can be set to frequencies at which the qubit implements a single qubit gate, frequencies at which a pair of qubits can implement a two-qubit gate, frequencies at which the qubit can be measured or readout, and frequencies at which the qubit can be reset or perform other operations.

In some implementations, e.g., when the qubits interact via couplers with fixed coupling, qubits can be configured to interact with one another by setting their respective operating frequencies at some gate-dependent frequency detuning from their common interaction frequency. In other implementations, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions can be performed in order to perform two-qubit or many-qubit gates.

In addition to quantum computing elements such as qubits and coupler, the quantum processor 108 also includes classical computing components. For example, the quantum processor 108 can include control devices that operate the multiple qubits, e.g., by applying control signals such as DC or AC voltage current pulses or by tuning the qubit's operating frequencies or tuning frequencies of couplers that couple the multiple qubits. Example control devices include arbitrary waveform generators, control signal synthesizers, and readout resonators. The type of control devices that the quantum processor 108 utilizes is dependent on the type of qubits the quantum processor 108 uses. As an example, qubits that are realized via atomic, molecular or solid-state quantum systems typically have energy separation of the relevant qubit levels in the microwave or optical domain. The states of such qubits can be manipulated and controlled using external fields, such as microwave or optical fields. In such cases, as an example, mode-locked lasers may serve as control electronics due to their broad-band optical spectra that feature both radio frequency and microwave structure. In another example, the control devices could include a collection of individual qubit controllers realized by a radio frequency generator as well as one or a collection of global excitation controllers realized by a radio frequency or microwave generator. In both cases, the control devices can be operated manually or connected to a computer and controlled via suitable software allowing for specifying and automatically running the required qubit operations.

The calibration system 106 is configured to repetitively calibrate operating parameters of computing elements included in the quantum processor 108. The calibration system 106 includes a calibration scheduler 118 and a calibration optimizer 120. The calibration scheduler 118 and calibration optimizer 120 can be classical computing components that perform classical computations. The operating parameters can generally include any control signals used to operate the computing elements and can vary based on the specific hardware implementation being used. For example, in cases where the qubits are frequency tunable, the operating parameters can include frequencies. However, the operating parameters can also include control signals for other hardware architectures, e.g., DC or AC voltage or current pulses, photons, etc. For convenience, this disclosure uses frequencies as a primary example of operating parameters, however this is a non-limiting example.

The calibration scheduler 118 is configured to schedule characterization data 124 to be taken from the quantum processor 108 and schedule the calibration of quantum processor operating parameters. Characterization data 124 includes data that is used to calibrate one or more calibration targets. e.g., operating parameters of a computing element included in the quantum processor 108. For example, the characterization data 124 can include data obtained by performing experiments on qubits included in the quantum processor. Performing an experiment on a qubit can include applying a static control waveform to the qubit and measuring the qubit, where during the experiment no qubit operational parameters are varied. The experiments can correspond to, for example, a gate sequence and measurement to determine the output probability distribution or a gate sequence and tomography to interrogate the state of the qubit. Each experiment can be repeated a number of times to gather statistics, e.g., to obtain a measured qubit energy-relaxation rates versus frequency, qubit dephasing rates versus frequency, and qubit or qubit crosstalk error amplitudes.

In some implementations the calibration scheduler 118 can be configured to implement a calibration scheduling strategy that formulates dependency relationships between operating parameters to be calibrated as a directed graph. Each operating parameter to be calibrated is represented by a node in the graph and dependency relationships between operating parameters are represented by respective directed edges in the graph, where the direction of the edge denotes which operating parameter depends on the other. The task of scheduling the operating parameters to be calibrated then becomes a graph traversal problem, where characterization data 124 can be taken at the traversed nodes by performing experiments, e.g., to extract current values of control and system parameters. The type of experiments performed at each traversed node can vary and include coarse-grain experiments that have interplay between fundamental operations and elements such as single-qubit gates, readout, and couplers. The experiments can also include fine-grain experiments that involve a more precise metrology for each qubit operation: single-qubit gates, two-qubit gates, and readout. Example operations performed by the calibration scheduler 118 are described in U.S. Pat. No. 9,940,212 titled “Automatic qubit calibration,” the contents of which are incorporated herein by reference.

The calibration optimizer 120 is configured to determine calibrated values of operating parameters 126 included in calibration schedules determined by the calibration scheduler 118. For example, in some implementations the calibration optimizer 120 can be configured to construct or receive a calibration model 122 that maps operating parameters and characterization data onto one or more relevant metrics, e.g., metrics correlated with system error such as N-qubit randomized benchmarking error or error suppression factor of a quantum error correction algorithm. The calibration optimizer 120 is configured to optimize the calibration model 122 with respect to one or more of the operating parameters to determine calibrated values of operating parameters 126, e.g., values that optimize the one or more relevant metrics. The calibration system 102 can provide the calibrated values of the operating parameters 126 to the quantum processor 108 to calibrate the quantum processor 108. In some implementations the calibration model 122 can include multiple component models, where each component model corresponds to a respective and distinct error channel, e.g., error due to energy-relaxation, error due to dephasing, or error die to crosstalk. Example calibration models are described in U.S. Pat. No. 11,556,813 titled “Refining qubit calibration models using supervised learning,” the contents of which are incorporated herein by reference.

In some implementations the calibration model 122 can be high-dimensional, high-constraint, and highly non-convex, e.g., in implementations where the operating parameters to be calibrated include interacting operating parameters such as logic gate frequencies. In these implementations, optimizing the calibration model 122 to obtain a globally optimal solution can be intractable. Therefore, in some implementations the calibration optimizer 120 can be configured to implement an optimization strategy that obtains locally optimal solutions, which have been empirically verified to be sufficient for state-of-the-art quantum computing applications. Example operations performed by the calibration optimizer 120 are described in US Publication No.: US20200387822 titled “Calibration of quantum processor operator parameters” and U.S. Pat. No. 11,361,241 titled “Optimizing qubit operating frequencies,” the contents of which are incorporated herein by reference.

The validation module 110 is configured to validate the status 128 of the quantum processor 108, e.g., check for calibration failures, software benchmarks and/or hardware benchmarks, and quantum algorithm metrics. For example, the validation module 110 can be configured to generate processor status validation data that includes values of validation metrics for some or all of the qubits and control devices included in the quantum processor.

The calibration system 106 is configured to repetitively/iteratively calibrate operating parameters of computing elements included in the quantum processor 108. At each repetition, data representing values of metrics that characterize the performance of the quantum processor 108 is generated by the calibration and quantum computing pipeline 102 and provided to the targeting system 104. These metrics are referred to herein as system metrics.

Each metric in the system metrics characterizes a respective operation that can be performed by one or more qubits included in the quantum processor 108. Example operations that can be performed by qubits included in the quantum processor 108 include single qubit operations, two-qubit operations, readout operations, and reset operations. In the present disclosure, system metrics that characterize single qubit operations are referred to as single qubit metrics, system metrics that characterize two qubit qubit operations are referred to as two qubit metrics, system metrics that characterize readout or reset qubit operations are referred to as readout or reset qubit metrics, respectively.

Different operations are sensitive to different quantum processor operating parameters. For example, a single qubit operation performed by a respective qubit is typically sensitive to a frequency at which the qubit implements the single qubit operation. As another example, a two qubit operation performed by a respective pair of qubits is typically sensitive to a frequency trajectory at which the pair of qubits implements the two qubit operation as well as the frequencies at which each qubit in the pair implements single qubit operations. In particular, the performance of a two qubit operation on a pair of qubits can depend on an idling frequency of one of the qubits in the pair. This is because, in some cases, a qubit can have a defect in its frequency spectrum that causes errors as the frequency of the qubit passes through resonance with the defect on the way to another frequency. These types of defects are frequently not modelled well. In cases such as this, system metrics associated with the idling frequency of the qubit, e.g., single qubit metrics for the qubit, can indicate that the qubit is performing well, however two qubit metrics that involve the qubit can indicate that the qubit is not performing well. It is often not enough to simply re-calibrate the frequency trajectory at which the qubit performs the two qubit operation. The idling frequency of the qubit may need recalibration in order to place the qubit in frequency space far away from the defect.

The performance of the operations can be measured in different quantities or using different protocols, e.g., in terms of qubit leakage or using benchmarking protocols such as cross entropy benchmarking or random benchmarking. Therefore, multiple metrics in the system metrics can correspond to a same operation. That is, each metric has a respective metric type that corresponds to the operation it characterize and a quantity or protocol used to measure the metric. Each metric also has a qubit index that indicates which qubit or subset of qubits the metric corresponds to. For example,

$${sq}_{i}^{k}$$

can represent a system metric that characterizes the performance of a single qubit operation sq being performed by qubit i and measured by quantity or protocol k. As another example,

$${tq}_{i , j}^{k}$$

can represent a system metric that characterizes the performance of a two qubit operation tq being performed by an interacting pair of qubits i,j and measured by quantity or protocol k.

In some implementations the values of the system metrics can include values that have been measured, e.g., by the calibration system 106 during a calibration procedure and/or collected as characterization data. Alternatively or in addition, the values of the system metrics can include values that have been modelled, e.g., if the metric is impractical to measure such as algorithm error.

At each calibration iteration/repetition, the calibration and quantum computing pipeline 102 can be configured to provide data 130 representing current values of metrics that characterize the performance of the quantum processor 108 to the targeting system 104. The targeting system 104 is configured to use the received data 130 to identify quantum processor operating parameters that should be re-calibrated in order to reduce the number of operating parameters that are currently performing anomalously worse than other operating parameters and improve the performance of the quantum processor 108.

In some implementations the current values of metrics that characterize the performance of the quantum processor may not be normalized. In these implementations, the normalization module 112 is configured to normalize the values so that each system metric has a distribution of values (over all qubits) that has a same distribution scale and can therefore be meaningfully compared. For example, the normalization module 112 can be configured to receive un-normalized values of the system metrics and compute a mean (or median) and standard deviation of each system metric over qubits that correspond to the system metric. The median could be used if the distribution is typically Gaussian with outliers, as the median can better indicate what the mean of the distribution without outliers is. Otherwise, the mean could be used. The normalization module 112 can then compute a z-score for each value of the system metric using the mean (or median) and standard deviation (i.e., compute z=(x−μ)/σ where x represents an un-normalized value, μ represents the mean, and σ represents the standard deviation). The z-scores can be used as normalized values of the system metrics 132 and provided to the effective metric generator 114.

The effective metric generator 114 is configured to determine values of effective system metrics for one or more of the system metrics. The effective system metrics characterize the performance of the quantum processor but also take into account dependencies between quantum processor operating parameters. For example, the effective metric generator 114 can be configured to determine effective single qubit metrics that correspond to respective single qubit metrics but also capture dependencies of two qubit metrics on the single qubit metrics. That is, each effective single qubit metric can be derived from the corresponding single qubit metric and two qubit metrics that correspond to pairs of qubits that include a same qubit as the corresponding single qubit metric. Therefore, the effective single qubit metrics more accurately characterize the operation of the quantum processor, i.e., indicate how important it is to recalibrate certain elements. For example, the values of the effective single qubit metrics can indicate that operating parameters for corresponding single qubits should be re-calibrated even if the values of the original single qubit metrics indicate that the single qubits are performing well but values of the two qubit metrics that involve the single qubits indicate that the single qubits are not performing well.

To determine an effective single qubit metric, the effective metric generator 114 can determine a predefined combination factor for the metric. The predefined combination factor represents a threshold number of values of two qubit metrics that exceed a predetermined outlier threshold, where the threshold number and outlier threshold are system parameters that can be specified by a user. A larger combination factor decreases a likelihood that an idling frequency for a qubit corresponding to the single qubit metric will require recalibration to move the idling frequency at least a predefined minimum distance away from a defect in a frequency spectrum for the qubit. In other words, the predefined combination factor can be defined as being equal to a number of outlier two qubit operations that should force an idling frequency move. The value of the combination factor can be defined based on the specific calibration application and quantum hardware and can be chosen to maximize the success of the algorithm based on the implementation and details of the hardware.

The effective metric generator 114 can use the combination factor to determine a two qubit metric contribution to amend to the single qubit metric and obtain an effective single qubit metric for the single qubit metric. For example, the effective metric generator 114 can compute a sum of two qubit metrics for pairs of qubits that include the qubit that corresponds to the single qubit metric, where the sum is divided by the combination factor, and amend this to the single qubit metric. The effective metric generator 114 can provide values of the effective system metrics 134 to the outlier identifier 116.

The outlier identifier 116 is configured to receive the normalized values of the system metrics 132 from the normalization module 112 and the values of the effective system metrics 134 from the effective metric generator 114 and process the received values to compute scores for each qubit. The scores indicate how well the qubits are performing with respect to different types system metrics, e.g., with respect to single qubit metrics, two qubit metrics, readout metrics, and reset metrics. That is, the combination factor, effective system metrics, and normalized values of the system metrics can form a map that takes as input metrics for computational elements and generates as output a score that indicates whether one or more computational elements should be targeted for recalibration.

To compute the scores, the outlier identifier 116 combines, for each qubit or set of qubits, values of system metrics of a same type that correspond to the qubit or set of qubits, e.g., by adding the values of system metrics in quadrature (where sign is preserved). In cases where the outlier identifier 116 receives values of effective system metrics for a qubit or for a set of qubits, the outlier identifier 116 can combine terms of the effective system metrics for the qubit or set of qubits in quadrature (where sign is preserved).

The outlier identifier 116 analyzes the scores to identify qubits with respective scores that exceed a predetermined threshold (in normalized units). As described above, it is common to observe that values of system metrics across a collection of qubits follows a normal distribution, with a small number of outlier qubits that perform anomalously worse than the main distribution. The predetermined threshold can correspond to an upper tail of the distribution, where scores that exceed the predetermined threshold are scores in the upper tail and are therefore outliers. The scores that exceed the predetermined threshold therefore correspond to qubits that are performing relatively poorly and require recalibration. (Note that scores in the lower tail correspond to outlier qubits that perform anomalously better than the main distribution, and would not need recalibrating). Like the combination factor, the outlier threshold is also a hyper parameter that can be determined based on the specific calibration application and quantum hardware.

The targeting system 104 can cause recalibration of qubits with scores that exceed the predetermined threshold, e.g., by transmitting data that identifies qubits and/or operating parameters of the qubits that require recalibration 136 to the calibration and quantum computing pipeline 102. The calibration and quantum computing pipeline 102 can then perform appropriate recalibration procedures on the qubits. In implementations where the targeting system 104 instructs the calibration and quantum computing pipeline 102 to recalibrate an idling frequency of a single qubit, the calibration and quantum computing pipeline 102 can automatically cause recalibration of frequencies for performing two qubit operations using pairs of qubits that include the single qubit.

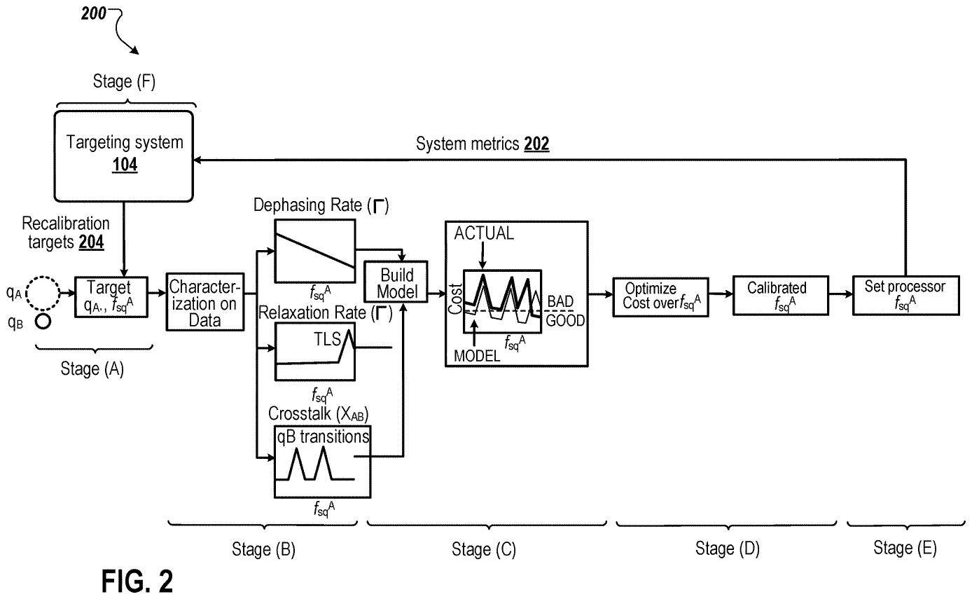

FIG. 2 is a block diagram 200 of an example workflow for calibrating calibration targets of a quantum processor. The example workflow can be implemented by a quantum computing system, e.g., the quantum computing system 100 of FIG. 1. For example, stages (A)-(E) can be performed by a calibration and quantum computing pipeline, e.g., the pipeline 102 of FIG. 1, and stage (F) can be performed by a targeting system, e.g., the targeting system 104 of FIG. 1.

During stage (A) of the example workflow, calibration targets are selected. In this example, the calibration target is a frequency

$${f}_{sq}^{A}$$

at which qubit q_{A} implements single qubit (sq) gates. In some implementations the calibration target can be selected by a calibration scheduler, e.g., the calibration scheduler 118 of FIG. 1, during implementation of a calibration scheduling strategy.

During stage (B) of the example workflow for calibrating an calibration target of a quantum processor, characterization data is taken from qubit q_{A}. For example, the calibration and quantum computing pipeline can perform experiments on qubit q_{A} to generate characterization data that provides information about the current behavior of qubit q_{A}. In the example shown in FIG. 2, three different types of experiments are performed on qubit q_{A}—including experiments that characterize the qubit's energy-relaxation rate Γ₁ versus the selected operating parameter

$${f}_{sq}^{A} ,$$

the qubit's dephasing rate Γ_{φ} versus the selected operating parameter

$${f}_{sq}^{A} ,$$

and amplitudes of the qubit's crosstalk error X_{AB} with qubit q_{B} versus the selected operating parameter

$${f}_{sq}^{A} .$$

However, in some implementations more experiments and experiments that are different from those shown in FIG. 2 can be performed.

During stage (C) of the example workflow, a calibration model is built using the characterization data generated at stage (B). In some implementations the calibration model can be built (or otherwise obtained) by a calibration optimizer, e.g., the calibration optimizer 120 of FIG. 1. During stage (D) of the example workflow, the calibration model built during stage (C) is optimized with respect to the selected operating parameter

$${f}_{sq}^{A}$$

to determine a calibrated value of the selected operating parameter

$${f}_{sq}^{A} .$$

In some implementations the calibration model can be optimized by a calibration optimizer, e.g., the calibration optimizer 120 of FIG. 1. During stage (E) of the example workflow, the value of the quantum processor operating parameter

$${f}_{sq}^{A}$$

is set to the calibrated value determined during stage (D).

During stage (F) of the example workflow, current values of system metrics 202 can be provided to the targeting system 104. The values of the system metrics are processed to identify targets for recalibration 204, as described above with reference to FIG. 1. The targets for recalibration are provided as input for a subsequent implementations of the example workflow.

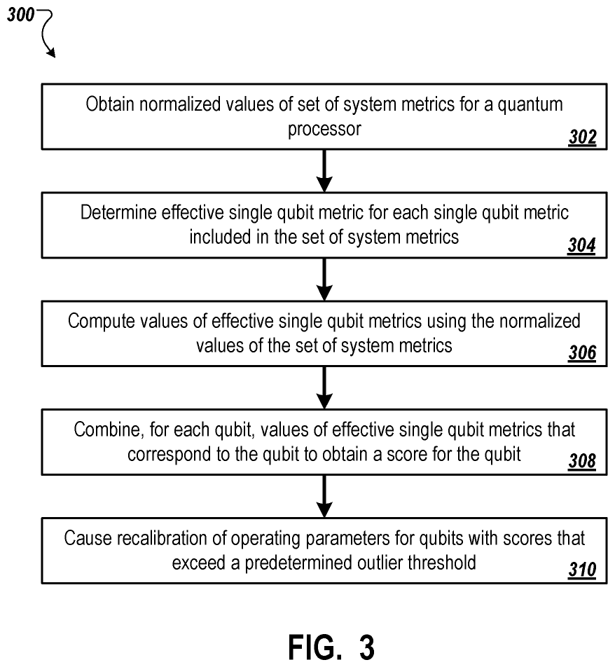

FIG. 3 is a flowchart of an example process 300 for identifying qubit operating parameters that require recalibration. For convenience, the process 300 will be described as being performed by a system of one or more classical computing devices located in one or more locations. For example, a targeting system in data communication with a calibration and quantum computing pipeline, e.g., the targeting system 104 in data communication with the calibration and quantum computing pipeline 102 of FIG. 1, appropriately programmed in accordance with this specification, can perform the process 300.

The system obtains normalized values of a set of system metrics for a quantum processor (step 302). The system metrics characterize the performance of the quantum processor. Each system metric in the set corresponds to a respective operation that can be performed by qubits included in the quantum processor, e.g., single qubit operations, two qubit operations, readout operations, and reset operations. System metrics that correspond to single qubit operations performed by respective single qubits are referred to as single qubit metrics. System metrics that correspond to two qubit operations performed by respective pairs of qubits are referred to as two qubit metrics. System metrics that correspond to readout or reset qubit operations performed by respective qubits are referred to as readout or reset qubit metrics, respectively. Each system metric also corresponds to a respective qubit or pair of qubits and a respective measure of performance, e.g., a quantity or protocol used to measure performance. The values of the set of system metrics can include measured or modelled values.

In some implementations the system can first obtain, e.g., receive, un-normalized values of the set of system metrics. In these implementations, the system can normalize the values. The system can use the un-normalized values to compute a mean (or median) and standard deviation of each system metric over qubits that correspond to the system metric. The system can then compute a z-score for each value of the system metric using the mean (or median) and standard deviation. The z-scores can be used as the normalized values of the system metrics.

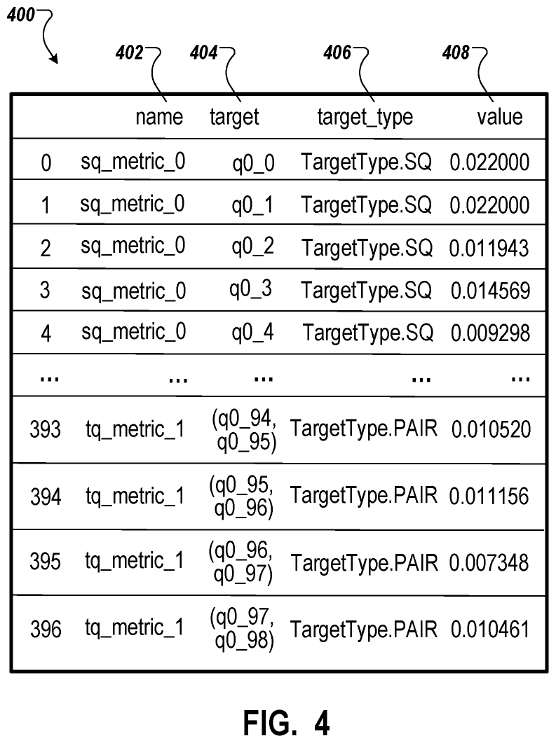

FIG. 4 is a table 400 that shows example un-normalized values of a set of system metrics for a quantum processor. Column 402 of the table 400 lists the system metrics included in the set. In this example, due to limited space, the system metrics only show one single qubit metric “sq_metric_0” and one two qubit metric “tq_metric_1”. However, the full table includes many more system metrics, e.g., sq_metric_0, sq_metric_1, sq_metric_2, . . . , sq_metric_k, tq_metric_0, tq_metric_1, . . . , tq_metric_k, . . . ” where 1 to k indexes the which quantity or protocol is used to measure the single qubit metric sq_metric or two qubit metric tq_metric.

Column 404 lists the targets of the system metrics, e.g., the qubits that the system metrics correspond to. Again, due to limited space, the targets only show five single qubits q0_0, q0_1, q0_2, q0_3, and q0_4 and five pairs of qubits (q0_94, q0_95), (q0_95, q0_96), (q0_96, q0_97), (q0_97, q0_98), and (q0_98, q0_99). However, the full table includes one hundred single qubits and combinations of pairs of the single qubits, e.g., q0_0, q0_1, . . . , q0_99, (q0_0, q0_1), (q0_1, q0_2), . . . (q0_98, q0_99).

Column 406 lists the type of the targets listed in column 404, e.g., whether the targets are single qubits “TargetType.SQ” or a pair of qubits “TargetType.PAIR”.

Column 408 lists un-normalized values of the system metrics listed in column 402 for each qubit or pair of qubits listed in column 404. For example, the un-normalized value of the system metric sq_metric_0 for qubit q0_0 is equal to 0.022000. The un-normalized value of the system metric tq_metric_1 for the pair of qubits (q0_94, q0_95) is equal to 0.010520.

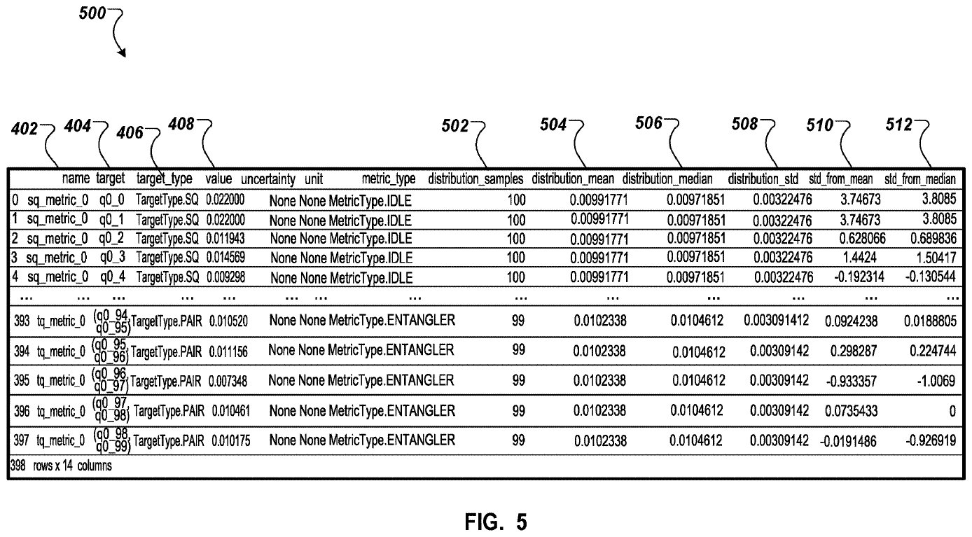

FIG. 5 is a table 500 that shows example normalized values of the un-normalized values of the set of system metrics shown in FIG. 4. Columns 402, 404, 406, and 408 of table 500 are the same as those in table 400 of FIG. 4. Column 502 of table 500 shows the number of samples included in the distribution of values for each system metric. In this example the number of samples included in the distribution of un-normalized values for system metric sq_metric_0 is 100 samples (corresponding to a value for each qubit q0_0-q0_99). The number of samples included in the distribution of un-normalized values for system metric tq_metric_1 is 99 samples.

Column 504 lists mean values of each system metric. For example, the mean value over the 100 samples for system metric sq_metric_0 is 0.00991771 and the mean value over the 99 samples for system metric tq_metric_1 is 0.0102338. Column 506 lists median values of each system metric. For example, the median value over the 100 samples for system metric sq_metric_0 is 0.00971851 and the median value over the 99 samples for system metric tq_metric_1 is 0.0104612. Column 508 lists standard deviations for each system metric. For example, the standard deviation of the 100 samples for system metric sq_metric_0 is 0.00322476 and the standard deviation of the 99 samples for system metric tq_metric_1 is 0.00309142.

Columns 510 and 512 list z-scores for each value of each system metric. The z-scores are the normalized values. For example, the z-score for qubit q0_0 and system metric sq_metric_0 is 3.74673 if the mean is used to compute the z-score and 3.8085 if the median is used to compute the z-score. The z-score for qubit q0_2 and system metric sq_metric_0 is 0.628066 if the mean is used to compute the z-score and 0.689836 if the median is used to compute the z-score.

Returning to FIG. 3, the system determines an effective single qubit metric for each single qubit metric included in the set of system metrics (step 304). Each effective single qubit metric is dependent on the corresponding single qubit metric and a sum of two qubit metrics corresponding to pairs of qubits that include a same qubit as the corresponding single qubit metric. Each effective single qubit metric is also dependent on a predefined combination factor, where the combination factor represents a threshold number of values of two qubit metrics that exceed the predetermined outlier threshold. A larger combination factor decreases a likelihood that an idling control signal (e.g. frequency) for a qubit corresponding to the single qubit metric will require recalibration to move the idling control signal at least a predefined minimum distance away from a defect in a frequency spectrum for the qubit.

The system uses the combination factor to determine a two qubit metric contribution to amend to the single qubit metric and obtain an effective single qubit metric for the single qubit metric. For example, the system can determine a sum of two qubit metrics that correspond to pairs of qubits that include the qubit that corresponds to the single qubit metric, where the sum is divided by the combination factor. The system can add this term to the single qubit metric to obtain an effective single qubit metric for the single qubit metric.

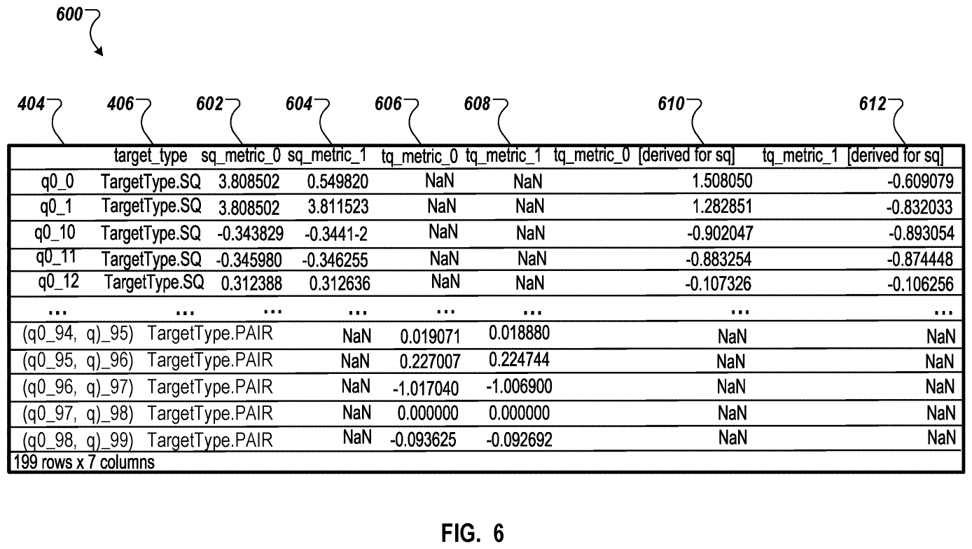

The system computes values of the effective single qubit metrics using the normalized values of the system metrics (step 306). FIG. 6 is a table 600 that shows example values of effective single qubit metrics for the normalized values of the set of system metrics shown in FIG. 5. Columns 404 and 406 of the table 600 are described above with reference to table 400 of FIG. 4. Column 602 is similar to column 512 in the table 500 shown in FIG. 5 and lists normalized values for the metric sq_metric_0 and each single qubit. Similarly, columns 604, 606, and 608 list example normalized values for metrics sq_metric_1, tq_metric_0, and tq_metric_1, respectively. Column 610 lists two qubit metric contributions for sq_metric_0, e.g., computed by summing two qubit metrics that correspond to pairs of qubits that include the qubit that corresponds to the sq_metric_0, where the sum is divided by a combination factor. Similarly, column 612 lists two qubit metric contributions for sq_metric_1.

Returning to FIG. 3, the system combines, for each qubit referenced by single qubit metrics in the system metrics, values of effective single qubit metrics that correspond to the qubit to obtain a score for the qubit (step 308). To combine effective single qubit metrics that correspond to the qubit to obtain a score for the qubit, the system can add terms of the effective single qubit metrics in quadrature, where sign is preserved. For example, the system can add normalized values of the single qubit metrics and corresponding values of two-qubit contribution terms in quadrature.

In some implementations, the system can also compute additional scores for each qubit, where the additional scores correspond to other types of system metrics. For example, the system can combine, for each qubit referenced by readout or reset qubit metrics in the set of system metrics, values of normalized readout or reset metrics that correspond to the qubit to obtain respective scores for the qubit. In addition, the system can combine, for each pair of qubits referenced by two qubit metrics in the system metrics, normalized values of the two qubit metrics that correspond to the pair of qubits to obtain a score for the pair of qubits.

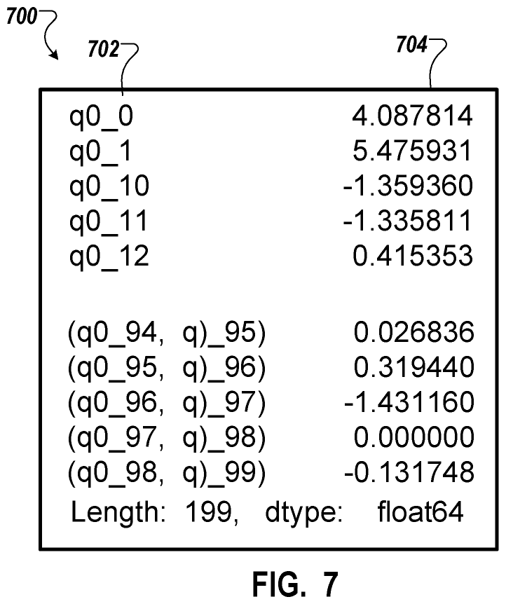

FIG. 7 is a table 700 that shows example qubit scores for the effective single qubit metrics and two qubit metrics included in the set of system metrics shown in FIG. 6. In this example, the score for qubit q0_0 is 4.087814 and has been obtained by adding values of terms of the effective single qubit metrics for single qubit metrics sq_metric_0 and sq_metric_1, e.g., adding the values for the single qubit metrics sq_metric_0, sq_metric_1 shown in columns 602 and 604 of FIG. 6 and values for the two-qubit contributions shown in columns 610 and 612 of FIG. 6. The values are added quadrature, where sign is preserved. For example, the score for qubit q0_0 is obtain via:

$$score ( q {0}_{0} ) = \sqrt{{( 3.808502 )}^{2} + {( 0.549820 )}^{2} + {( 1.508050 )}^{2} - {( 0.609079 )}^{2}} = 4.087814 .$$

As another example, the score for the pair of qubits (q0_94, q0_95) is 0.026836 and has been obtained by adding values of terms of the two qubit metrics tq_metric_0 and tq_metric_1 in quadrature, e.g., 0.026836=\sqrt{(0.019071)²+(0.018880)²}.

Returning to FIG. 3, the system causes recalibration of operating parameters, e.g., qubit frequencies (or more generally control signals), of qubits with scores that exceed a predetermined outlier threshold (step 310). For example, if a qubit score for the effective single qubit metrics is above the predetermined outlier threshold, the system can calibrate the frequencies (or more generally control signals) at which the qubit performs single qubit operations, e.g., its idling frequency and frequencies at which the qubit performs single qubit gates. In implementations where the system causes recalibration of a qubit's idling frequency, the system can also automatically cause recalibration of frequencies for performing two qubit operations using pairs of qubits that include the qubit. As another example, if a score for a pair of qubits is above the predetermined outlier threshold, the system can calibrate the frequencies (or more generally control signals) at which the pair of qubits performs two qubit operations, e.g., frequency trajectories for two qubit gates. To cause recalibration of operating parameters, the system can transmit instructions that instruct the calibration and quantum computing pipeline to recalibrate the operating parameters.

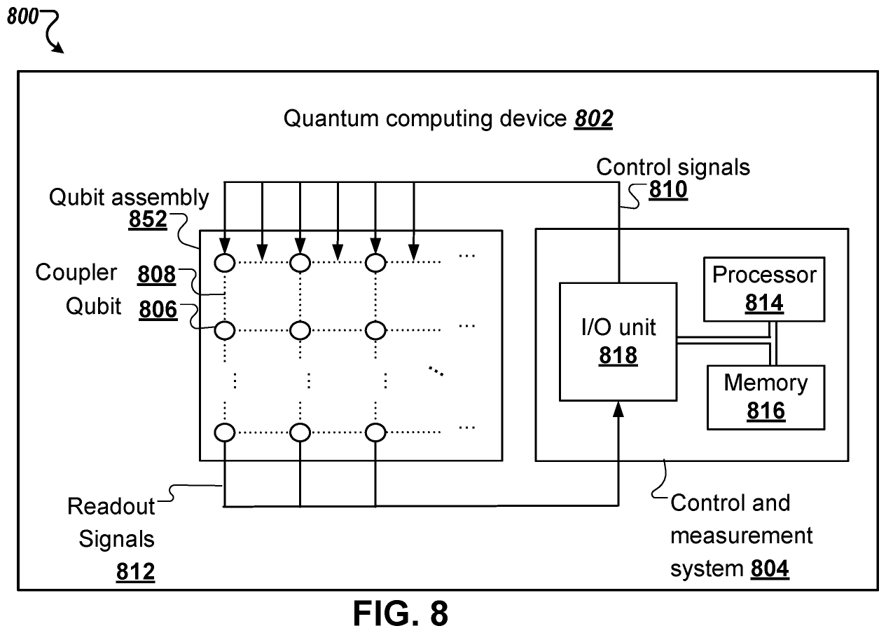

FIG. 8 depicts an example quantum processor 800 that can be included in the calibration and quantum computing pipeline described in this specification. The example quantum processor 800 includes an example quantum computing device 802. The quantum computing device 802 is intended to represent various forms of quantum computing devices. The components shown here, their connections and relationships, and their functions, are exemplary only, and do not limit implementations of the inventions described and/or claimed in this document.

The example quantum computing device 802 includes a qubit assembly 852 and a control and measurement system 804. The qubit assembly includes multiple physical qubits, e.g., qubit 806, that are used to perform algorithmic operations or quantum computations. While the qubits shown in FIG. 8 are arranged in a rectangular array, this is a schematic depiction and is not intended to be limiting. The qubit assembly 852 also includes adjustable coupling elements, e.g., coupler 808, that allow for interactions between coupled qubits. In the schematic depiction of FIG. 8, each qubit is adjustably coupled to each of its four adjacent qubits by means of respective coupling elements. However, this is an example arrangement of qubits and couplers and other arrangements are possible, including arrangements that are non-rectangular, e.g., hexagonal, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 802 included in the example computer 800 or the type of quantum computations that the quantum computing device is performing. For example, in an atomic quantum computer the qubits can be realized via atomic, molecular or solid-state quantum systems, e.g., hyperfine atomic states. As another example, in a superconducting quantum computer the qubits can be realized via superconducting qubits or semi-conducting qubits, e.g., superconducting transmon states. As another example, in a NMR quantum computer the qubits can be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits. Example quantum logic gates include single-qubit gates, e.g., Pauli-X, Pauli-Y. Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT), iSWAP gates, and gates involving three or more qubits, e.g., Toffoli gates. The quantum logic gates can be implemented by applying control signals 810 generated by the control and measurement system 804 to the qubits and to the couplers.

For example, in some implementations the qubits in the qubit assembly 852 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 810 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X, Y, or Z, using respective control signals 810. The measurements cause readout signals 812 representing measurement results to be communicated back to the measurement and control system 804. The readout signals 812 may include RF, microwave, or optical signals depending on the physical scheme for the quantum computing device and/or the qubits. For convenience, the control signals 810 and readout signals 812 shown in FIG. 8 are depicted as addressing only selected elements of the qubit assembly (i.e. the top and bottom rows), but during operation the control signals 810 and readout signals 812 can address each element in the qubit assembly 852.

The control and measurement system 804 is an example of a classical computer system that can be used to perform various operations on the qubit assembly 852, as described above, as well as other classical subroutines or computations. The control and measurement system 804 includes one or more classical processors, e.g., classical processor 814, one or more memories, e.g., memory 816, and one or more I/O units, e.g., I/O unit 818, connected by one or more data buses. The control and measurement system 804 can be programmed to send sequences of control signals 810 to the qubit assembly, e.g. to carry out a selected series of quantum gate operations, and to receive sequences of readout signals 812 from the qubit assembly, e.g. as part of performing measurement operations and post processing measurement results.

The processor 814 is configured to process instructions for execution within the control and measurement system 804. In some implementations, the processor 814 is a single-threaded processor. In other implementations, the processor 814 is a multi-threaded processor. The processor 814 is capable of processing instructions stored in the memory 816.

The memory 816 stores information within the control and measurement system 804. In some implementations, the memory 816 includes a computer-readable medium, a volatile memory unit, and/or a non-volatile memory unit. In some cases, the memory 816 can include storage devices capable of providing mass storage for the system 804, e.g. a hard disk device, an optical disk device, a storage device that is shared over a network by multiple computing devices (e.g., a cloud storage device), and/or some other large capacity storage device.

The input/output device 818 provides input/output operations for the control and measurement system 804. The input/output device 818 can include D/A converters, A/D converters, and RF/microwave/optical signal generators, transmitters, and receivers, whereby to send control signals 810 to and receive readout signals 812 from the qubit assembly, as appropriate for the physical scheme for the quantum computer. In some implementations, the input/output device 818 can also include one or more network interface devices, e.g., an Ethernet card, a serial communication device, e.g., an RS-232 port, and/or a wireless interface device, e.g., an 802.8 card. In some implementations, the input/output device 818 can include driver devices configured to receive input data and send output data to other external devices. e.g., keyboard, printer and display devices.

Although an example control and measurement system 804 has been depicted in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the digital and/or quantum subject matter and the digital functional operations and quantum operations described in this specification can be implemented in digital electronic circuitry, suitable quantum circuitry or, more generally, quantum computational systems, in tangibly-embodied digital and/or quantum computer software or firmware, in digital and/or quantum computer hardware, including the structures disclosed in this specification and their structural equivalents, or in combinations of one or more of them. The term “quantum processors” may include, but is not limited to, quantum computers, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry. e.g., an FPGA or an ASIC, or a quantum simulator, or by a combination of special purpose logic circuitry or quantum simulators and one or more programmed digital and/or quantum computers.

For a system of one or more digital and/or quantum computers to be “configured to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum processors or both, or any other kind of central digital and/or quantum processing unit. Generally, a central digital and/or quantum processing unit will receive instructions and digital and/or quantum data from a read-only memory, a random access memory, or quantum systems suitable for transmitting quantum data, e.g. photons, or combinations thereof.

The essential elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data. e.g., magnetic, magneto-optical disks, optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM. EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more non-transitory machine-readable storage media, and that are executable on one or more digital and/or quantum processing devices. The systems described in this specification, or portions of them, can each be implemented as an apparatus, method, or system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a set of normalized values of system metrics for a quantum processor, wherein the system metrics comprise single qubit metrics that correspond to respective qubits and two qubit metrics that correspond to respective pairs of qubits;
determining, for each single qubit metric, an effective single qubit metric, wherein the effective single qubit metric comprises the single qubit metric and a sum of two qubit metrics corresponding to pairs of qubits that include a same qubit as the single qubit metric;
computing, using the normalized values of the system metrics, values of the effective single qubit metrics;
combining, for each qubit referenced by single qubit metrics in the system metrics, effective single qubit metrics that correspond to the qubit to obtain a score for the qubit; and
causing recalibration of operating parameters of qubits with scores that exceed a predetermined outlier threshold.

2. The method of claim 1, wherein the operating parameters of a qubit comprise control signals for performing single qubit operations using the qubit.

3. The method of claim 2, wherein the control signals for performing single qubit operations using the qubit comprise an idling control signal, and wherein causing recalibration of the idling control signal further comprises causing recalibration of control signals for performing two qubit operations using pairs of qubits that include the qubit.

4. The method of claim 1, further comprising:
combining, for each pair of qubits referenced by two qubit metrics in the system metrics, normalized values of the two qubit metrics that correspond to the pair of qubits to obtain a score for the pair of qubits; and
causing recalibration of operating parameters of pairs of qubits with scores that exceed the predetermined outlier threshold.

5. The method of claim 1, wherein the system metrics further comprise readout metrics that correspond to respective qubits and reset metrics that correspond to respective qubits, and wherein the method further comprises:
combining, for each qubit referenced by the readout metrics or reset metrics in the system metrics, normalized values of the readout metrics or reset metrics that correspond to the qubit; and
causing recalibration of operating parameters of qubits with scores that exceed the predetermined outlier threshold.

6. The method of claim 1, wherein an effective single qubit metric for a single qubit metric further comprises a predefined combination factor, wherein the combination factor represents a threshold number of values of two qubit metrics that exceed the predetermined outlier threshold.

7. The method of claim 6, wherein a larger combination factor decreases a likelihood that an idling control signal for a qubit corresponding to the single qubit metric will require recalibration to move the idling control signal at least a predefined minimum distance away from a defect in a control signal spectrum for the qubit.

8. The method of claim 6, wherein determining an effective single qubit metric comprises determining a sum of two qubit metrics that correspond to pairs of qubits that include the qubit that corresponds to the single qubit metric divided by the combination factor.

9. The method of claim 1, wherein combining effective single qubit metrics that correspond to the qubit to obtain a score for the qubit comprises adding terms of the effective single qubit metrics in quadrature, wherein sign is preserved.

10. The method of claim 1, wherein obtaining the set of normalized values of the system metrics comprises:
receiving a set of un-normalized values of the system metrics;
computing, using the received set of un-normalized values, a mean or median and standard deviation of each system metric over qubits that correspond to the system metric; and
computing a z-score for each value of the system metric using the mean or median and standard deviation.

11. The method of claim 1, wherein the values of the system metrics comprise measured or modelled values.

12. The method of claim 1, wherein each system metric corresponds to a respective operation, a respective qubit or pair of qubits, and a respective measure of performance.

13. The method of claim 1, wherein the set of normalized values of system metrics are obtained after the quantum processor has been calibrated.

14. A system comprising:
a data processing apparatus; and
a non-transitory computer readable storage medium in data communication with the data processing apparatus and storing instructions executable by the data processing apparatus and upon such execution cause the data processing apparatus to perform operations comprising:
obtaining a set of normalized values of system metrics for a quantum processor, wherein the system metrics comprise single qubit metrics that correspond to respective qubits and two qubit metrics that correspond to respective pairs of qubits;
determining, for each single qubit metric, an effective single qubit metric, wherein the effective single qubit metric comprises the single qubit metric and a sum of two qubit metrics corresponding to pairs of qubits that include a same qubit as the single qubit metric;
computing, using the normalized values of the system metrics, values of the effective single qubit metrics;
combining, for each qubit referenced by single qubit metrics in the system metrics, effective single qubit metrics that correspond to the qubit to obtain a score for the qubit; and
causing recalibration of operating parameters of qubits with scores that exceed a predetermined outlier threshold.

15. A computer-readable storage medium comprising instructions stored thereon that are executable by a processing device and upon such execution cause the processing device to perform operations comprising:
obtaining a set of normalized values of system metrics for a quantum processor, wherein the system metrics comprise single qubit metrics that correspond to respective qubits and two qubit metrics that correspond to respective pairs of qubits;
determining, for each single qubit metric, an effective single qubit metric, wherein the effective single qubit metric comprises the single qubit metric and a sum of two qubit metrics corresponding to pairs of qubits that include a same qubit as the single qubit metric;
computing, using the normalized values of the system metrics, values of the effective single qubit metrics;
combining, for each qubit referenced by single qubit metrics in the system metrics, effective single qubit metrics that correspond to the qubit to obtain a score for the qubit; and
causing recalibration of operating parameters of qubits with scores that exceed a predetermined outlier threshold.
claim 1.
